(19) United States
(12) Patent Application Publication
(10) Pub. No.: US 2026/0250438 A1
(43) Pub. Date: Aug. 27, 2026

(54) POLYOLEFIN COMPOSITIONS FOR INJECTION MOLDING

(71) Applicant: Dow Global Technologies LLC, Midland, MI (US)

(72) Inventors: Xiaosong Wu, Sugar Land, TX (US); Lena T. Nguyen, Lake Jackson, TX (US); Rhett A. Baillie, Missouri City, TX (US)

(21) Appl. No.: 18/875,804

(22) PCT Filed: Aug. 4, 2023
(86) PCT No.: PCT/US2023/029532

§ 371 Date: Dec. 17, 2024

Related U.S. Application Data
(60) Provisional application No. 63/395,376, filed on Aug. 5, 2022.
(60) Provisional application No. 63/395,369, filed on Aug. 5, 2022.

(51) Int. Cl. C08F 210/16

(52) U.S. Cl. CPC C08F 210/16

(57) ABSTRACT

Embodiments of the present disclosure are directed towards polyolefin compositions, useful for injection molding, made with asymmetrical hafnium metallocenes having an n-propyl cyclopentadienyl ligand, processes utilizing the polyolefin compositions, and products made with the compositions.

### FIELD OF DISCLOSURE

Embodiments of the present disclosure are directed towards polyolefin compositions useful for injection molding.

### BACKGROUND

The use of polyolefin compositions in the formation of injection molded articles is generally known. Any conventional method may be employed to produce such polyolefin compositions. Various polymerization techniques using different catalyst systems have been employed to produce such polyolefin compositions suitable for the formation of articles.

### SUMMARY

The present disclosure provides various embodiments, including, without limitation, the following.

A polyolefin composition, wherein the polyolefin composition has: a density from 0.925 to 0.955 g/cm³; a melt index (I₂) from 30 to 130 dg/min; a reverse comonomer distribution; a secant modulus at 1% greater than 70 kilopounds per square inch; a Mn of 7,000 to 15,000; a Mw of 25,000 to 60,000; a Mz of 55,000 to 160,000; and a molecular weight distribution (Mw/Mn) from 2.0 to 3.5.

### BRIEF DESCRIPTION OF DRAWINGS

FIG. 1 is a plot of heat distortion temperature vs density in accordance with one or more embodiment of the present disclosure.

### DETAILED DESCRIPTION

Injection molding is a process for producing articles by injecting molten material, e.g., polymer, into a mold. Molten material that is injected into the mold can be cooled so that the molten material hardens configured to the mold to make the article. Injection molding is a well-known process.

Injection molding can be utilized to make thin wall articles, such as containers and lids for instance. Such molding can be referred to as thin wall molding. Thin wall injection molding applications can utilize a polymer, e.g., a polyolefin composition. For thin wall applications, it can be desirable for the polymer to have a number of properties, e.g., high stiffness, high impact strength, high environmental stress cracking resistance (ESCR) and good creep resistance, a reverse comonomer distribution and a number of processing attributes. Additionally, the articles can have an improved, e.g., greater, high temperature resistance, as shown by a relationship between polymer density and heat distortion temperature.

Polyolefin compositions that are useful for injection molding are discussed herein. Advantageously, the present disclosure provides a unimodal polyolefin compositions with a reverse comonomer distribution and one or more desirable processability parameters, as compared to other injection molding compositions. The polyolefin compositions disclosed herein can provide that thin wall articles made by injection molding have desirable functional, durability, safety, and/or aesthetic qualities that are sought after for various applications.

The polyolefin compositions discussed herein are made with asymmetrical hafnium metallocenes having an n-propyl cyclopentadienyl ligand. These polyolefin compositions can have a number of desirable properties, such as having a reverse comonomer distribution (defined when the MWCDI>0). Further these polyolefin compositions can have one or more desirable processability parameters.

The asymmetrical hafnium metallocenes having an n-propyl cyclopentadienyl ligand can be represented by structure (I):

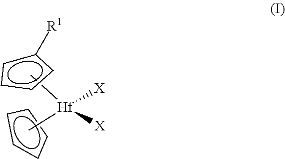

wherein: R¹ is n-propyl, and each X is independently a leaving group. As shown in structure (I), the upper cyclopentadienyl ring is substituted with the R¹ group, and the lower cyclopentadienyl ring is unsubstituted. As one cyclopentadienyl ring is substituted with the R¹ group and the other cyclopentadienyl ring is unsubstituted, i.e., the cyclopentadienyl ligands are different, the metallocenes can be referred to as asymmetrical hafnium metallocenes.

Embodiments of the present disclosure provide that X is a leaving group. One or more embodiments provide that X is selected from alkyls, aryls, hydridos, and halogens. One or more embodiments provide that X is selected from a halogen, (C₁-C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂)aryls, (C₇ to C₂₀)alkylaryls, (C₁ to C₁₂)alkoxys, (C₆ to C₁₆)aryloxys, (C₇ to C₈)alkylaryloxys, (C₁ to C₁₂)fluoroalkyls, (C₆ to C₁₂)fluoroaryls, and (C₁ to C₁₂)heteroatom-containing hydrocarbons and substituted derivatives thereof; one or more embodiments include hydrides, halogen ions, (C₁ to C₆)alkyls, (C₂ to C₆)alkenyls, (C₇ to C₁₈)alkylaryls, (C₁ to C₆)alkoxys, (C₆ to C₁₄)aryloxys, (C₇ to C₁₆)alkylaryloxys, (C₁ to C₆)alkylcarboxylates, (C₁ to C₆)fluorinated alkylcarboxylates, (C₆ to C₁₂)arylcarboxylates, (C₇ to C₁₈)alkylarylcarboxylates, (C₁ to C₆)fluoroalkyls, (C₂ to C₆)fluoroalkenyls, and (C₇ to C₁₈)fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂)aryls, (C₇ to C₂₀)alkylaryls, substituted (C₁ to C₁₂)alkyls, substituted (C₆ to C₁₂)aryls, substituted (C₇ to C₂₀)alkylaryls, and (C₁ to C₁₂)heteroatom-containing alkyls, (C₁ to C₁₂)heteroatom-containing aryls, and (C₁ to C₁₂)heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆)alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

The asymmetrical hafnium metallocenes having an n-propyl cyclopentadienyl ligand discussed herein can be made by contacting a hafnium complex with an alkali metal complex to make the asymmetrical hafnium metallocenes having an n-propyl cyclopentadienyl ligand. The asymmetrical hafnium metallocenes having an n-propyl cyclopentadienyl ligand discussed herein can be made by processes, e.g., with conventional solvents, reaction conditions, reaction times, and isolation procedures, utilized for making known metallocenes.

The alkali metal complex can be represented by one of the following structures:

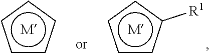

wherein M′ is lithium, sodium, or potassium and R¹ is n-propyl.

One or more embodiments provide that the hafnium complex can be represented by one the following structures:

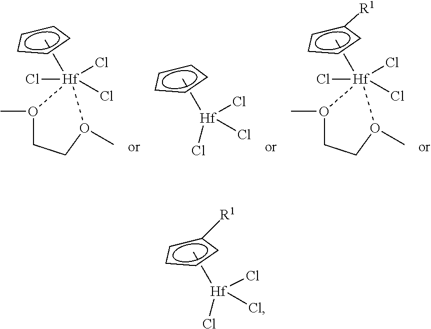

wherein R¹ is n-propyl.

One or more embodiments provide that making the asymmetrical hafnium metallocenes having an n-propyl cyclopentadienyl ligand, e.g., where each X is Cl, comprises contacting the asymmetrical hafnium metallocenes having an n-propyl cyclopentadienyl ligand with two mole equivalents of an organomagnesium halide of formula RMg(halide) or one mole equivalent of R²Mg, wherein R is (C₁-C₅)alkyl, CH₂SiMe₃, or benzyl; and the halide is Cl or Br, to make the asymmetrical hafnium metallocenes having an n-propyl cyclopentadienyl ligand of structure (I) wherein each X is a halogen, a (C₁-C₅)alkyl, CH₂SiMe₃, or benzyl. One or more embodiments provide X is a (C₁-C₅)alkyl, CH₂SiMe₃, or benzyl. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl” group can be a C₆ to C₂₀ aryl group. For example, a C₆H₅ aromatic structure is an “phenyl”, a C₆H₄ 2 aromatic structure is an “phenylene”. An “arylalkyl” group is an alkyl group having an aryl group pendant therefrom. It is understood that an “aralkyl” group can be a (C₇ to C₂₀ aralkyl group. An “alkylaryl” is an aryl group having one or more alkyl groups pendant therefrom.

As used herein, an “alkylene” includes linear, branched and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group.

The asymmetrical hafnium metallocenes having an n-propyl cyclopentadienyl ligand discussed herein can be utilized to make catalyst compositions, e.g., injection molding compositions. These compositions include the asymmetrical hafnium metallocenes discussed herein and an activator. The asymmetrical hafnium metallocenes discussed herein and the activator can be contacted to make a catalyst composition. One or more embodiments provide that the activator is an alkylaluminoxane such as methylaluminoxane. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g., the asymmetrical hafnium metallocene having an n-propyl cyclopentadienyl ligand of Structure (I). The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized. Various amounts of known catalyst composition components may be utilized for different applications.

The asymmetrical hafnium metallocenes having an n-propyl cyclopentadienyl ligand discussed herein can be utilized to make spray-dried compositions. As used herein, “spray-dried composition” refers to a composition that includes a number of components that have undergone a spray-drying process. Various spray-drying process are known in the art and are suitable for forming the spray-dried compositions disclosed herein. One or more embodiments provide that the spray-dried composition comprises a trim composition.

In one or more embodiments, the spray-drying process may comprise atomizing a composition including the asymmetrical hafnium metallocene having an n-propyl cyclopentadienyl ligand discussed herein. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the asymmetrical hafnium metallocene having an n-propyl cyclopentadienyl ligand discussed herein. Such a solution typically may be made in an inert hydrocarbon solvent, for instance, and is sometimes called a trim solution. Such a spray-dried composition comprised of contacting a trim solution of the asymmetrical hafnium metallocene having an n-propyl cyclopentadienyl ligand with a spray dried activator particle, such as spray-dried MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 75 to 185° C. Other drying temperatures are possible, where the temperature can depend on the metallocene and activator particle. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

In one or more embodiments, a supported catalyst can be made by removing the solvent, e.g., by vacuum, rather than utilizing a spray-drying process.

The asymmetrical hafnium metallocenes having an n-propyl cyclopentadienyl ligand discussed herein, such as the spray-dried hafnium metallocene composition, may be utilized to make a polymer. For instance, the asymmetrical hafnium metallocene having an n-propyl cyclopentadienyl ligand may be activated, i.e., with an activator, to make a catalyst. One or more embodiments provide that the spray-dried compositions include an activator. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the asymmetrical hafnium metallocene having an n-propyl cyclopentadienyl ligand may be 1500:1 to 0.5:1, 300:1 to 1:1, or 150:1 to 1:1. One or more embodiments provide that the molar ratio of in the activator to hafnium in the asymmetrical hafnium metallocene having an n-propyl cyclopentadienyl ligand is at least 75:1. One or more embodiments provide that the molar ratio of in the activator to hafnium in the asymmetrical hafnium metallocene having an n-propyl cyclopentadienyl ligand is at least 100:1. One or more embodiments provide that the molar ratio of in the activator to hafnium in the asymmetrical hafnium metallocene having an n-propyl cyclopentadienyl ligand is at least 150:1.

The asymmetrical hafnium metallocenes having an n-propyl cyclopentadienyl ligand discussed herein, as well as a number of other components, can be supported on the same or separate supports, or one or more of the components may be used in an unsupported form. Utilizing the support may be accomplished by any technique used in the art. One or more embodiments provide that the spray-dry process is utilized. The support may be functionalized. One or more embodiments provide that the spray-dried compositions include a support.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica, One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The asymmetrical hafnium metallocenes having an n-propyl cyclopentadienyl ligand discussed herein, and an olefin can be contacted under polymerization conditions to make a polymer, e.g., a polyolefin polymer. The polymerization process may be a solution polymerization process, a suspension polymerization process, a slurry polymerization process, and/or a gas phase polymerization process. The polymerization process may utilize using known equipment and reaction conditions, e.g., known polymerization conditions. The polymerization process is not limited to any specific type of polymerization system. The polymer can be utilized for a number of articles, such as injection molded articles, e.g., thin wall containers and/or lids.

One or more embodiments provide that the polymers are made utilizing a gas-phase reactor system. One or more embodiments provide that a single gas-phase reactor, e.g., in contrast to a series of reactors, is utilized. In other words, polymerization reaction occurs in only one reactor. For instance, the polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Polyolefin compositions discussed herein can made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polymer can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polymer. The polymer can include from 0.1 to 50 wt % of units derived from comonomer based on the total weight of the polymer. One or more embodiments provide that ethylene is utilized as a monomer and hexene is utilized as a comonomer.

As mentioned, the polymers made with the compositions disclosed herein can be made in a fluidized bed reactor. The fluidized bed reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, 110, 100, 90, 80, 70, or 60° C.

The fluidized bed reactor can have an ethylene partial pressure from 30 to 250 pounds per square inch (psi). All individual values and subranges from 30 to 250 are included; for example, the fluidized bed reactor can have an ethylene partial pressure from a lower limit of 30, 45, 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, or 0.010 to an upper limit of 0.100, 0.080, or 0.050.

When hydrogen is utilized for a polymerization process, the fluidized bed reactor can have a hydrogen to ethylene mole ratio (H₂/C₂) from 0.00001 to 0.90000, for instance. All individual values and subranges from 0.00001 to 0.90000 are included; for example, the fluidized bed reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

Compositional Conventional GPC was determined as follows.

The chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{poly} = A \times {( {M}_{poylstyrene} )}^{B} \qquad ( EQ 1 )$$

where M is the molecular weight, A has a value of 0.4056 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCONE software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {{M}_{{polyethylene}_{i}}}^{2} )}{{\sum }^{i} ( {IR}_{i} * {M}_{{polyethylene}_{i}} )} \qquad ( EQ 4 )$$

To monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎ for each sample by RV alignment of the respective decane peak within the sample (RV_{(FM Sample)} to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 5. Processing of the flow marker peak was done via the PolymerChar GPCONE Software. Acceptable flowrate correction is such that the effective flowrate should be within +/−0.5% of the nominal flowrate.

$${Flowrate}_{( effective )} = {Flowrate}_{( nominal )} * ( {RV}_{( FMCalibrated )} / {RV}_{( FMsample )} ) \qquad ( EQ 5 )$$

### IR5 GPC Octene Composition Calibration

A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“Copolymer” Standards

| | IR5 | SCB/ | | |
|---|---|---|---|---|
| Wt % | Area | 1000 | | |
| Comonomer | ratio | Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Area Ratio” was constructed in the form of the following Equation 6:

$$Wt \% Comonomer = {A}_{0} + [ {A}_{1} \times ( IR {5}_{MethylChannelArea} / IR {5}_{MeasurementChannelArea} ) ] \qquad ( EQ 6 )$$

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

The comonomer content, e.g., 1-hexene, incorporated in the polymers was determined by rapid FT-IR spectroscopy on the dissolved polymer in a GPC measurement. Comonomer content was determined with respect to polymer molecular weight by use of an infrared detector (an IR5 detector) in a gel permeation chromatography measurement, as described in Analytical Chemistry 2014, 86(17), 8649-8656. “Toward Absolute Chemical Composition Distribution Measurement of Polyolefins by High-Temperature Liquid Chromatography Hyphenated with Infrared Absorbance and Light Scattering Detectors” by Dean Lee, Colin Li Pi Shan, David M. Meunier, John W. Lyons, Rongjuan Cong, and A. Willem deGroot. Analytical Chemistry 2014 86(17), 8649-8656.

The comonomer distribution, or short chain branching distribution, in an ethylene/α-olefin copolymer can be characterized as either normal (also referred to as having a Zeigler-Natta distribution), reverse, or flat. Several reported methods are utilized to quantify a Broad Orthogonal Composition Distribution (BOCD). Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, wherein the x-axis is Log(MW) and the y-axis is weight percent of comonomer. Short chain branching (SCB) was excluded from the MWCDI calculation according to the formula 0.5>(SCBF)*(MW detector response) wherein SCBF is the SCB frequency measured in SCB/1000C. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. Polymers with a relatively greater MWCDI, i.e., BOCD, can provide one or more improved physical properties, as compared to polymers having a relatively lesser MWCDI.

The polyolefin compositions disclosed herein are unimodal, e.g., in contrast to bimodal. As used herein, “unimodal” refers to polymers that can be characterized by having one peak in a GPC chromatogram showing the molecular weight distribution. Furthermore, a unimodal composition is a composition that is made by utilizing a single catalyst, e.g., a single polyethylene catalyst, in a single reactor. This distinguishes the unimodal composition, as defined above, from bimodal compositions that may appear to have one peak in the GPC chromatogram showing the molecular weight distribution. These bimodal compositions are those that are made by one or more polyethylene catalysts in a staged reactor process, typically a dual reactor process including but not limited to two solution polymerization reactors, or two gas phase polymerization reactors, or two slurry phase polymerization reactors, or combinations thereof such as a sequential slurry and gas phase polymerization reactors, such that two different polymers of different densities, and optionally molecular weights are made in the different reactors. The two or more reactors may be in series or parallel or some combination thereof. These approaches can provide an improved MWCDI compared to what the individual polyethylene catalyst or catalysts can achieve independently. In the case where the MW of two components of the bimodal are similar enough the polymer may appear to have a single peak in a GPC chromatogram. As this composition required at least two reactors and one or more polyethylene catalysts this is defined as a bimodal composition. Additionally, two or more polyethylene catalysts in a single solution, slurry, or gas phase reactor may produce such a bimodal polymer as described above that appears to have a single peak in a GPC chromatogram showing the molecular weight distribution. This would also be defined as a bimodal polymer composition.

The polyolefin compositions disclosed herein can have a MWCDI from 0.10 to 10.00. All individual values and subranges from 0.10 to 10.00 are included; for example, the polyolefin composition can have a MWCDI from a lower limit of 0.10, 0.50, or 1.00 to an upper limit of 10.00, 9.00, 8.00, 8.50, or 8.35.

The polyolefin compositions disclosed herein can have a density from 0.925 to 0.955 g/cm³. All individual values and subranges from 0.925 to 0.955 g/cm³ are included; for example, the polyolefin composition can have a density from a lower limit of 0.925, 0.930, 0.935, 0.940, or 0.942 g/cm³ to an upper limit of 0.955 or 0.954 g/cm³. Density can be determined by according to ASTM D792.

The polyolefin compositions disclosed herein can have a secant modulus at 1% greater than 70 ksi. For example, the polyolefin compositions disclosed herein can have a secant modulus at 1% from 71 to 250 ksi. All individual values and subranges from 71 to 250 ksi are included; for example, the polyolefin composition can have a secant modulus at 1% from a lower limit of 71, 75, 85, 90, 95, 105, 115, or 125 ksi to an upper limit of 250, 225, or 200 ksi. Secant Modulus at 1% can be determined according to ASTM D790 (0.5 in/min).

The polyolefin compositions disclosed herein can have a secant modulus at 2% greater than 60 ksi. For example, the polyolefin compositions disclosed herein can have a secant modulus at 2% from 61 to 200 ksi. All individual values and subranges from 61 to 200 ksi are included; for example, the polyolefin composition can have a secant modulus at 2% from a lower limit of 61, 65, 70, 75, 80, 90, 101, 105, or 110 ksi to an upper limit of 200, 175, or 150 ksi. Secant Modulus at 1% can be determined according to ASTM D790 (0.5 in/min).

The polyolefin compositions disclosed herein can have a melt index (I₂) from 30 to 130 dg/min. 12 can be determined according to ASTM D1238 (190° C., 2.16 kg). All individual values and subranges from 30 to 130 dg/min are included; for example, the polyolefin composition can have an 12 from a lower limit of 30, 40, or 55 dg/min to an upper limit of 130, 120, 110, or 90 dg/min.

The polyolefin compositions disclosed herein can have a weight average molecular weight (Mw) from 25,000 to 60,000 g/mol. All individual values and subranges from 25,000 to 60,000 g/mol are included; for example, the polyolefin composition can have an Mw from a lower limit of 25,000, 30,000 or 35,000 g/mol to an upper limit of 60,000, 50,000, or 40,000 g/mol. Mw can be determined by gel permeation chromatography (GPC), as is known in the art. GPC is discussed herein.

The polyolefin compositions disclosed herein can have a number average molecular weight (Mn) from 7,000 to 15,000 g/mol. All individual values and subranges from 7,000 to 15,000 g/mol are included; for example, the polyolefin composition can have an Mn from a lower limit of 7,000, 8,500, or 10,000 g/mol to an upper limit of 15,000, 14,500 or 14,000 g/mol. Mn can be determined by GPC.

The polyolefin compositions disclosed herein can have a Z-average molecular weight (Mz) from 55,000 to 160,000 g/mol. All individual values and subranges from 55,000 to 160,000 g/mol are included; for example, the polyolefin composition can have an Mz from a lower limit of 55,000, 60,000, or 70,000 g/mol to an upper limit of 160,000, 130,000, or 100,000 g/mol. Mz can be determined by GPC.

The polyolefin compositions disclosed herein can have a weight average molecular weight to number average molecular weight ratio (Mw/Mn) from 2.0 to 3.5. All individual values and subranges from 2.0 to 3.5 are included; for example, the polyolefin composition can have an Mw/Mn from a lower limit of 2.0, 2.2, or 2.5 to an upper limit of 3.5, 3.2, or 3.0 Mw/Mn may also be referred to as molecular weight distribution or “MWD”.

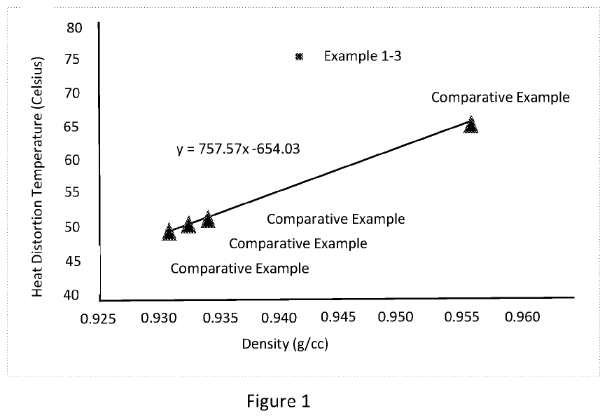

FIG. 1 is a plot of heat distortion temperature vs density in accordance with one or more embodiment of the present disclosure. The polyolefin compositions disclosed herein can have a higher temperature resistance, as shown by a relationship between polymer density and heat distortion temperature. One or more embodiments provide that the polyolefin compositions has a heat distortion temperature and density relationship such that: heat distortion temperature≥757.57 (density)−645.

The polyolefin compositions disclosed herein can have a −40° C. Charpy impact strength greater than 5.5 KJ/m². For instance, the polyolefin composition can have a −40° C. Charpy impact strength from 5.6 KJ/m² to 10.0 KJ/m². All individual values and subranges from 5.6 KJ/m² to 10.0 KJ/m² are included; for example, the polyolefin composition can have a −40° C. Charpy impact strength from a lower limit of 5.6, 5.65, or 5.7 KJ/m² to an upper limit of 10.0, 9.5 or 9.5 KJ/m². −40° C. Charpy impact strength can be determined in accordance with ISO 179 at −40° C.

The polyolefin compositions disclosed herein can have a 23° C. IZOD impact strength greater than 39 J/m. For instance, the polyolefin composition can have a 23° C. IZOD impact strength from 40 J/m to 85 J/m. All individual values and subranges from 40 J/m to 85 J/m are included; for example, the polyolefin composition can have a 23° C. IZOD impact strength from a lower limit of 40, 42, or 45 J/m to an upper limit of 85, 80, or 65 J/m. 23° C. IZOD impact strength can be determined according to ASTM D256 at 23° C.

The polymers made with the compositions disclosed herein can advantageously, e.g., due to providing a reverse comonomer distribution and describable processing attributes, for an injection molding process to make an injection molding article. Injection molding is a well-known process, which can be used to produce thin wall containers, for instance.

The injection molding process can be performed with known equipment and known conditions. For example, the injection molding process can be performed at injection temperatures from 180 to 280° C. and injection speeds in a range from 10 to 500 mm/sec. Mold temperatures may range from 0 to 80° C., for instance.

A number of aspects of the present disclosure are provided as follows.

Aspect 1 provides a polyolefin composition, wherein the polyolefin composition has: a density from 0.925 to 0.955 g/cm³; a melt index (I₂) from 30 to 130 dg/min; a reverse comonomer distribution; a secant modulus at 1% greater than 70 kilopounds per square inch; a Mn of 7,000 to 15,000; a Mw of 25,000 to 60,000; a Mz of 55,000 to 160,000; and a molecular weight distribution (Mw/Mn) from 2.0 to 3.5.

Aspect 2 provides the polyolefin composition of aspect 1, wherein the polyolefin composition has a 23° C. IZOD impact strength greater than 39 J/m.

Aspect 3 provides the polyolefin composition of any one of aspects 1-2, wherein the polyolefin composition has a secant modulus at 2% greater than 60 kilopounds per square inch.

Aspect 4 provides the polyolefin composition of any one of aspects 1-3, wherein the polyolefin composition has molecular weight comonomer distribution index (MWCDI) greater than 1.

Aspect 5 provides the polyolefin composition of any one of aspects 1-3, wherein the polyolefin composition has molecular weight comonomer distribution index (MWCDI) greater than 2.5.

Aspect 6 provides the polyolefin composition of any one of aspects 1-5, wherein the polyolefin composition has a heat distortion temperature and density relationship such that: heat distortion temperature≥757.57 (density)−645.

Aspect 7 provides the polyolefin composition of any one of aspects 1-6, wherein ethylene is utilized as a monomer and hexene is utilized as a comonomer.

Aspect 8 provides the polyolefin composition of any one of aspects 1-7, wherein the polyolefin composition is unimodal.

Aspect 9 provides an injection molding article made with the polyolefin composition of any one of aspects 1-8.

Aspect 10 provides a method for making the polyolefin composition of any one of aspects 1-8, the method comprising:
making a catalyst composition utilizing an asymmetrical hafnium metallocene having an n-propyl cyclopentadienyl ligand represented by structure (I):

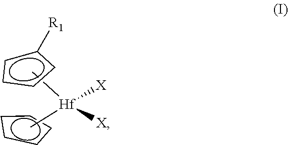

wherein R¹ n-propyl; and each X is independently a leaving group; and contacting the catalyst composition and ethylene and, optionally, a comonomer selected from the group consisting of propene and a (C₄-C₂₀) alpha-olefins to make the polyolefin composition.

### EXAMPLES

Hafnium complex I: (n-Propylcylopentadienyl)hafnium trichloride, dimethoxyethane adduct, which may be represented by the following formula:

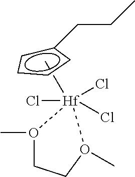

was synthesized as follows. The (n-Propylcylopentadienyl)hafnium trichloride, dimethoxyethane adduct was synthesized as follows (e.g., by adapting the procedure described in WO2016/168448A1 by Harlan). Bis-(n-propylcyclopentadienyl) hafnium dichloride was commercially obtained from TCl; Bis(n-propylcyclopentadienyl)hafnium dichloride (25.1 g, 54.1 mmol) was heated to 140° C. in a 100 mL round-bottom flask until melted. HfCl₄ (17.5 g, 54.6 mmol) was added to the flask as a solid powder. The contents of the flask were heated at 140° C. for approximately 30 minutes and formed a brown viscous liquid. The 100 mL round bottom flask was attached to a short path distillation apparatus, which consisted of a glass tube (90° bend) that was attached to a Schlenk flask. A vacuum was pulled through a stopcock of the Schlenk flask. Distillation was performed from 105° C. to 110° C. with 0.4 torr vacuum. In approximately one hour, it was observed that most of the material distilled/sublimed into the Schlenk flask or remained in the glass tube. The solid material in the u-tube was scraped out and combined with the material in the Schlenk flask. To this solid was added toluene (50 mL) and dimethoxyethane (50 mL). This was heated to reflux forming a solution, additional toluene (50 mL) was added. Upon cooling colorless needles formed. Pentane (200 mL) was added causing further formation of solid precipitate. The solid was isolated by filtration, washed with pentane (2×50 mL) and dried under vacuum to provide (n-Propylcylopentadienyl)hafnium trichloride, dimethoxyethane adduct (42.2 g); cooling the combined supernatant and washings resulted an additional 2.6 g of product that was isolated.

Example 1-1, an asymmetrical hafnium metallocene having an n-propyl cyclopentadienyl ligand, which may be represented by the following structure (II):

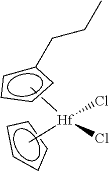

was synthesized as follows. For the above formula, R¹, as previously discussed, is (n-propyl). In a glove box, (n-propylcylopentadienyl)hafnium trichloride, dimethoxyethane adduct (0.75 g, 1.56 mmol) was added to a container (oven-dried 4 oz. glass jar); a teflon-coated stir bar and 40 mL of dry toluene (40 mL) were added to the container and the contents were stirred. The contents were observed to be grey and cloudy. Cyclopentadienyllithium (1 molar equivalent) was slowly added the container; then, the contents of the container were stirred for approximately 12 hours at approximately 20° C. NMR spectra indicated formation of Example 1-1, as well as some unreacted starting material. The contents of the container were further stirred for approximately 120 hours at approximately 20° C.; then, the contents of the container were filtered and volatiles were removed under reduced pressure. The solids were recrystallized from warm hexanes and toluene; the resultant solids (Example 1-1) were isolated (63.9% total yield after recrystallization). ¹H and ¹³C NMR spectra confirmed Example 1-1. ¹H NMR (400 MHz, Benzene-d₆) δ 5.86 (s, 3H), 5.77-5.72 (m, 2H), 5.57 (t, J=2.7 Hz, 2H), 2.63-2.54 (m, 2H), 1.48-1.35 (m, 2H), 0.80 (t, J=7.3 Hz, 3H). ¹³C NMR (101 MHZ, Benzene-d₆) δ 132.81, 115.78, 114.13, 110.86, 32.38, 24.34, 14.00.

Example 1-2, a spray-dried composition, was made as follows. To a container (13 gallon tank) hydrophobic fumed silica (CABOSIL TS-610; 2.38 pounds) and a 10% solution (37.0 pounds) by weight of methylaluminoxane (MAO) in toluene were added while mixing. Then, Example 1-1 (80 grams) and toluene (20 pounds) were added to the contents of the container while mixing. Then, the contents of the container were spray-dried (146° C. inlet temperature; 84° C. outlet temperature; 14 lbs/hr slurry inlet feed, 20000 rpm atomizer speed) to provide Example 1-2 (4.1 pounds).

Example 1-3 (polyolefin composition) was made utilizing Example 1-2 as follows. The polymerization utilized a pilot scale fluidized bed gas phase polymerization reactor that included a reactor vessel containing a fluidized bed of a powder of ethylene/alpha-olefin copolymer, and a distributor plate disposed above a bottom head, and defining a bottom gas inlet, and having an expanded section, or cyclone system, at the top of the reactor vessel to decrease resin fines that may escape from the fluidized bed. The expanded section defined a gas outlet. The reactor further included a compressor blower that was utilized to continuously cycle gas around from out of the gas outlet in the expanded section in the top of the reactor vessel through a cycle loop down to and into the bottom gas inlet of the reactor and through the distributor plate and fluidized bed. The reactor further included a cooling system that removed heat of polymerization and maintained the fluidized bed at a target temperature. Compositions of gases such as ethylene, alpha-olefin, and hydrogen were fed into the reactor and monitored by an in-line gas chromatograph in the cycle loop to maintain specific concentrations that were used to control polymer properties. The spray-dried catalyst was fed as a slurry or dry powder into the reactor from high pressure devices, wherein the slurry was fed via a syringe pump and the dry powder was fed via a metered disk. The catalyst entered the fluidized bed in the lower ⅓ of the bed height. The polymerization system weighed the fluidized bed and included isolation ports that discharged the polymerization product from the reactor vessel in response to an increase of the fluidized bed weight as the polymerization reaction proceeded. Polymerization conditions are reported in Table 1.

Commercial obtained polymers were utilized as comparative examples: Comparative Example A (unimodal Commercial grade DMDA-8962 NT from Dow, made with Ziegler-Natta catalyst, density of 0.935 g/cm³, melt index (I₂) of 60.5 dg/min); Comparative Example B (unimodal Commercial grade DMDA-8965 from Dow, made with Ziegler-Natta catalyst, density of 0.953 g/cm³, melt index (I₂) of 65 dg/min); Comparative Example C (unimodal Commercial grade DMDB-1077 from Dow, made with Ziegler-Natta catalyst, density of 0.929 g/cm³, melt index (I₂) of 100 dg/min); Comparative Example D (unimodal Commercial grade DMDB-1081 from Dow, made with Ziegler-Natta catalyst, density of 0.931 g/cm³, melt index (I₂) of 128 dg/min); Comparative Example E (unimodal Commercial grade DMDB-1082A from Dow, made with Ziegler-Natta catalyst, density of 0.933 g/cm³, melt index (I₂) of 155 dg/min); Comparative Example F (polymer made with XCAT VP 100 catalyst comprising bis(n-proylcyclopentadienyl)hafnium dimethyl), density of 0.953 g/cm³, melt index (I₂) of 41 dg/min).

A number of properties were determined for the polyolefin compositions. The results are reported in Table 2-6. Melt index (I₂) was determined according to ASTM D1238 (190° C., 2.16 kg), melt index (I₅) was determined according to ASTM D1238 (190° C., 5 kg); Mw, Mn, Mz, and Mw/Mn were determined by GPC; molecular weight comonomer distribution index (MWCDI) was determined as discussed herein. IZOD impact strength was determined according to ASTM D256 at and 23° C. Charpy impact strength was determined in accordance with ISO 179 at 0° C., −10° C. and 23° C. Flexural Modulus, secant Modulus at 1%, and secant Modulus at 2% were determined according to ASTM D790 (0.5 in/min) and are reported in kilopounds per square inch (KSI). Tensile strength was determined according to ASTM D638. Heat distortion temperature was determined was determined according to ASTM D648.

The term “n-hexane extractables”, as used herein, refers to an amount of n-hexane soluble material cleaned out of the resultant polymer composition by n-hexane. The extraction process follows both the Food and Drug Administration (FDA) procedure for determining the solvent extractable portion of polyolefin (21 CFR 177.1520 (d)(3)(ii) and ASTM D5227. Polymer pellets were pressed or extruded to film with a thickness of 3 to 4 mils, then cut into 1×1 inch square pieces. Film pieces are weighed (2.5±0.05 g) then placed in a basket then extracted for two hours in a n-hexane vessel at 49.5±0.5° C. in a heated water bath, as described in ASTM D5227. After two hours, the films are removed, rinsed with clean n-hexane, and dried in a vacuum oven (80±5° C.) at full vacuum for two hours. The films were then placed in a desiccator and allowed to cool to room temperature for a minimum of one hour. The films were then reweighed, and the amount of mass loss due to extraction in n-hexane was calculated. n-Hexane extractable is reported as wt %.

TABLE 1

| | | Example |
|---|---|---|
| | | 1-3 |
| Reaction | ° C. | 80 |
| Temp | | |
| C₆/C₂ | mol/mol | 0.0074 |
| H₂/C₂ | mol/mol | 0.0021 |
| C₂ | psi | 129 |
| Partial | | |
| Pressure | | |
| Catalyst | cm³/hr | 14 |
| slurry feed | | |
| rate | | |
| Reactor | psi | 349 |
| pressure | | |
| Average | hr | 3.19 |
| residence | | |
| time | | |
| Average | lb | 145 |
| Bed Weight | | |
| Productivity | lb/lb | 7,570 |

TABLE 2

| | | Example |
|---|---|---|
| | | 1-3 |
| Modality | | Unimodal |
| Density | g/cm³ | 0.943 |
| (g/cm³) | | |
| Mn | g/mol | 13,973 |
| Mw | g/mol | 37,550 |
| Mz | g/mol | 75,878 |
| Mw/Mn | | 2.7 |
| Melt Index | dg/min | 70.5 |
| (I₂) | | |
| MWCDI | | 2.65 |

TABLE 3

| | | Comp. | Comp. | Comp. | Comp. | Comp. | Comp. |
|---|---|---|---|---|---|---|---|
| | | Ex. A | Ex. B | Ex. C | Ex. D | Ex. E | Ex. F |
| Density | g/cm³ | 0.944 | 0.953 | 0.929 | 0.931 | 0.933 | 0.953 |
| Mn | g/mol | 10,079 | 9,625 | 8,714 | 8,242 | 7,885 | 13,272 |
| Mw | g/mol | 40,544 | 41,663 | 36,712 | 33,777 | 31,749 | 43,085 |
| Mz | g/mol | 144,668 | 165,544 | 140,274 | 123,445 | 110,021 | 103,376 |
| Mw/Mn | | 4.0 | 4.3 | 4.2 | 4.1 | 4.0 | 3.2 |
| Melt | dg/min | 60.5 | 40.0 | 100.0 | 127.5 | 155.0 | 40.0 |
| Index | | | | | | | |
| (I₂) | | | | | | | |
| MWCDI | | −2.24 | −0.51 | −3.72 | −3.60 | −3.71 | 0.73 |

The data of Table 2 illustrate that Example 1-3 (polyolefin composition made with Example 1-2) had a molecular weight comonomer distribution index (MWCDI) greater than 1, i.e. a reverse comonomer distribution.

The data of Table 2 illustrate that polyolefin composition Example 1-3 had a density from 0.925 to 0.955 g/cm³.

The data of Table 2 illustrate that polyolefin composition Example 1-3 had an 12 from 30 to 130 dg/min.

The data of Table 2 illustrate that polyolefin composition Example 1-3 had Mw/Mn from 2.0 to 3.5.

TABLE 4

| | | Example |
|---|---|---|
| Property | Unit | 1-3 |
| 0° C. Charpy impact strength | J/m | 27.2 |
| −10° C. Charpy impact strength | J/m | 26.3 |
| 23° C. Charpy impact strength | J/m | 28.5 |
| 23° C. IZOD impact strength | J/m | 46.8 |
| Flexural modulus | ksi | 155 |
| Secant modulus | ksi | 133 |
| at 1% | | |
| Secant Modulus | ksi | 114 |
| at 2% | | |
| Elongation | % | 59.9 |
| Strain at yield | % | 9.7 |
| Stress at break | psi | 1,976 |
| Stress at yield | psi | 3,154 |
| Heat distortion temperature | ° C. | 76 |
| Hexane extractable content | % | 0.33 |

TABLE 5

| | | Comp. | Comp. | Comp. | Comp. | Comp. | Comp. |
|---|---|---|---|---|---|---|---|
| | | Ex. A | Ex. B | Ex. C | Ex. D | Ex. E | Ex. F |
| 0° C. Charpy | J/m | 26.4 | 22.0 | 50.8 | 18.4 | 16.7 | — |
| impact strength | | | | | | | |
| −10° C. Charpy | J/m | 23.1 | — | 56.5 | 17.6 | 5.0 | — |
| impact strength | | | | | | | |
| 23° C. Charpy | J/m | 22.8 | 22.0 | 51.8 | 20.4 | 19.5 | 20.5 |
| impact strength | | | | | | | |
| 23° C. IZOD | J/m | 35.2 | 19.7 | 52.4 | 38.6 | 33.3 | 31.9 |
| impact strength | | | | | | | |
| Flexural modulus | ksi | 144 | 151 | 81 | 100 | 116 | 186 |
| Secant modulus | ksi | 127 | 133 | 67 | 78 | 98 | 153 |
| at 1% | | | | | | | |
| Secant Modulus | ksi | 109 | 113 | 61 | 73 | 83 | 132 |
| at 2% | | | | | | | |
| Elongation | % | 17 | 5 | 134 | 40 | 20 | 77 |
| Strain at yield | % | 6.1 | 3.3 | 11.1 | 9.5 | 9.4 | 8.3 |
| Stress at break | psi | 3046 | 3708 | 1272 | 1578 | 2288 | 1301 |
| Stress at yield | psi | 2970 | 3256 | 2244 | 2004 | 2328 | 3975 |
| Heat distortion | ° C. | | 68 | 50 | 51 | 52 | |
| temperature | | | | | | | |
| Hexane extractable | % | | 0.65 | 3.87 | | 4.08 | 0.22 |
| content | | | | | | | |

1. A polyolefin composition, wherein the polyolefin composition has:
a density from 0.925 to 0.955 g/cm³;
a melt index (I₂) from 30 to 130 dg/min;
a reverse comonomer distribution;
a secant modulus at 1% greater than 70 kilopounds per square inch;
a Mn of 7,000 to 15,000;
a Mw of 25,000 to 60,000;
a Mz of 55,000 to 160,000; and
a molecular weight distribution (Mw/Mn) from 2.0 to 3.5.

2. The polyolefin composition of claim 1, wherein the polyolefin composition has a 23° C. IZOD impact strength greater than 39 J/m.

3. The polyolefin composition of claim 1, wherein the polyolefin composition has a secant modulus at 2% greater than 60 kilopounds per square inch.

4. The polyolefin composition of claim 1, wherein the polyolefin composition has molecular weight comonomer distribution index (MWCDI) greater than 1.

5. The polyolefin composition of claim 1, wherein the polyolefin composition has molecular weight comonomer distribution index (MWCDI) greater than 2.5.

6. The polyolefin composition of claim 1, wherein the polyolefin composition has a heat distortion temperature and density relationship such that: heat distortion temperature≥757.57 (density)−645.

7. The polyolefin composition of claim 1, wherein ethylene is utilized as a monomer and hexene is utilized as a comonomer.

8. The polyolefin composition of claim 1, wherein the polyolefin composition is unimodal.

9. An injection molding article made with the polyolefin composition of claim 1.

10. A method for making the polyolefin composition of claim 1, the method comprising:
making a catalyst composition utilizing an asymmetrical hafnium metallocene; and contacting the catalyst composition and ethylene and, optionally, a comonomer selected from the group consisting of propene and a (C₄-C₂₀) alpha-olefins to make the polyolefin composition.

11. The method of claim 10, wherein the asymmetrical hafnium metallocene has an n-propyl cyclopentadienyl ligand and the asymmetrical hafnium metallocene can represented by structure (I): 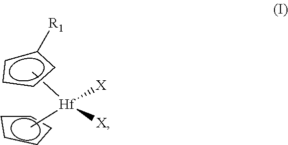
wherein R¹ n-propyl; and each X is independently a leaving group.
